(19) United States
(12) Patent Application Publication
(10) Pub. No.: US 2013/0196684 A1
(43) Pub. Date: Aug. 1, 2013

(54) GENERATING INDOOR RADIO MAP, LOCATING INDOOR TARGET

(71) Applicant: International Business Machines Corporation, Armonk, NY (US)

(72) Inventors: Jin Dong, Beijing (CN); Miao He, Beijing (CN); Jinfeng Li, Beijing (CN); Fei Liu, Beijing (CN); Changrui Ren, Beijing (CN)

(73) Assignee: International Business Machines Corporation, Armonk, NY (US)

(21) Appl. No.: 13/753,616

(22) Filed: Jan. 30, 2013

(30) Foreign Application Priority Data
Jan. 31, 2012 (CN) 201210021393.5

(51) Int. Cl. H04W 4/04

(52) U.S. Cl. CPC H04W 4/04
USPC 455/456.1

(57) ABSTRACT

A method and system of generating an indoor radio map. In order to reduce the influence of multipath effect on indoor localization and improve the accuracy of indoor localization, a technique of processing data for indoor target locating and a technique of locating an indoor target based on the above technique is proposed. The method for generating an indoor radio map performs a smoothing process on the wireless signal strength measured in at least one position by a mobile node based on wireless signal strengths measured by the mobile node at adjacent positions, so as to reduce the influence of multipath effect.

### CROSS-REFERENCE TO RELATED APPLICATION

This application claims priority under 35 U.S.C. §119 from Chinese Patent Application No. 201210021393.5 filed Jan. 31, 2012, the entire contents of which are incorporated herein by reference.

### BACKGROUND OF THE INVENTION

1. Field of the Invention

The embodiments of the present invention generally relate to a method and system of processing data, and more specifically, to a method and system of generating an indoor radio map, and a method and system of locating an indoor target.

2. Description of the Related Art

With the rapid increase of data services and multimedia services, there is an increasing demand for locating and navigation, especially, in complicated indoor environments, such as airport halls, exhibition halls, storehouses, supermarkets, libraries, underground parking, mines and the like, it is usually needed to determine indoor position information of a mobile terminal or its holder, a facility or an item. However, an indoor environment is a complicated environment, in which signals can suffer a large decay during propagation due to indoor persons, items and walls, making it difficult to accurately locate persons or items in indoor environments.

Currently, GPS is the most widely employed locating technology. Although GPS technology has found its considerably mature industrial applications in outdoor locating, when a GPS receiver works indoors, wireless signals from satellites can greatly decay due to the effect of buildings, so that the GPS receiver cannot receive enough satellite signals and fail to perform indoor localization. With the development of wireless communication technology, newly developed wireless network techniques, e.g., WiFi, CDMA, ZigBee, Bluetooth, and ultra-wide band and the like have been widely applied in offices, homes, factories, etc.

It has been noted by the present inventors that several techniques have been disclosed in the prior art for performing indoor localization through wireless signal transmission, for example, a method for locating an indoor target through environmental wireless signals has been disclosed in a U.S. Pat. No. 6,799,047B1. A mobile computer detects wireless signals transmitted from several indoor base stations, by comparing an electronic map of known locations under different environments and the wireless signal strengths transmitted from the base stations which have been currently detected by the mobile computer, a known position having the closest signal strength is obtained as the position of the current mobile computer. However, in the prior art, it is unable to eliminate a severe influence of multipath effect on accurate locating.

The multipath effect refers to an interference effect caused by a multipath transmission phenomenon in radio wave propagation channels. In a practical radio wave transmission channel, because there are many buildings and obstacles at the signal transmitting and receiving ends, which can cause phenomena such as radio wave dispersion, reflection, refraction and the like, the radio wave received at the receiving end is the superposition of radio waves transmitted over several paths, and because radio waves over various paths can have changes in phase, the resultant superposed signal can lead to the rapid fading of the radio wave, consequently, the strength of the superposed radio waves cannot truly reflect the distance between the transmitting end and the receiving end. The multipath effect has a serious impact on digital communication and radar optimum detection. If there is a small displacement at the signal transmitting end, the radio signal strength received at the receiving end can have a great change, making it impossible for the radio wave signal strength to truly reflect the distance between a signal receiving end and a signal transmitting end.

The severe impact on indoor localization of multipath effect has not been noticed in the prior art, as a result, the result of indoor localization according to the prior art can deviate seriously from the actual position of a target (which will be discussed in more detail hereinafter).

In order to reduce the impact of multipath effect on indoor localization and improve the accuracy of indoor localization, the present invention provides a technique of processing data for indoor target locating, and a technique of locating indoor target based on the above technique.

### SUMMARY OF THE INVENTION

According to a first embodiment of the present invention, a method for generating an indoor radio map, wherein an indoor environment is configured to be provided with wireless sensor nodes and at least one mobile node. The mobile node can move in the indoor environment and can perform wireless signal transmission with the wireless sensor nodes. The method includes measuring the wireless signal strengths transmitted between the wireless sensor nodes and the mobile node at different indoor positions; performing a smoothing process on wireless signal strengths measured by the mobile node in at least one position; and generating an indoor radio map according to the smoothed wireless signal strengths.

The present invention further provides a system for generating an indoor radio map, wherein an indoor environment is configured to be provided with wireless sensor nodes and at least one mobile node, the mobile node can move in the indoor environment, and the mobile node can perform wireless signal transmission with the wireless sensor nodes, the system includes a first measuring device configured to measure the wireless signal strengths transmitted between the wireless sensor nodes and the mobile node at different indoor positions; a smoothing device configured to perform a smoothing process on wireless signal strengths measured by the mobile node in at least one position; and a generating device configured to generate an indoor radio map according to the smoothed wireless signal strengths.

The present invention can reduce the impact of multipath effect on indoor localization and improve the accuracy of indoor localization.

### BRIEF DESCRIPTION OF THE DRAWINGS

The above and other objects, features and advantages of the present invention can be better understood through the detailed description of embodiments of the present invention with reference to the following accompanying drawings. In these drawings, the same reference numbers are generally used to indicate the same parts throughout the embodiments.

FIG. 1 shows a block diagram of an exemplary computing system applicable to implement one embodiment of the present invention.

FIG. 2 shows a flowchart of a method for generating an indoor radio map according to the present invention.

FIG. 3 shows a schematic diagram of the layout of wireless sensor nodes according to one embodiment of the present invention.

FIG. 4 is a diagram showing the variation of measured wireless signal strengths transmitted between a mobile node and a wireless sensor node with positions according to one embodiment of the present invention.

FIG. 5 is a schematic diagram showing measured wireless signal strengths that have been smoothed according to one embodiment of the present invention.

FIG. 6A shows a schematic diagram of a single input single output (SISO) signal transmission structure according to one embodiment of the present invention.

FIG. 6B shows a schematic diagram of a single input multiple output (SIMO) signal transmission structure according to one embodiment of the present invention.

FIG. 6C shows a schematic diagram of a multiple input single output (MISO) signal transmission structure according to one embodiment of the present invention.

FIG. 6D shows a schematic diagram of a multiple input multiple output (MIMO) signal transmission structure according to one embodiment of the present invention.

FIG. 7 shows a schematic diagram of a mobile node according to one embodiment of the present invention.

FIG. 8 shows a flowchart of a method for locating an indoor target according to the present invention.

FIG. 9 shows a schematic diagram of signal strengths without removing indoor localization error caused by multipath effect.

FIG. 10 shows a schematic diagram of signal strengths with the multipath effect being reduced thereby improving the location accuracy according to one embodiment of the present invention.

FIG. 11 shows a block diagram of a system of generating an indoor radio map according to the present invention.

FIG. 12 shows a block diagram of a system of locating an indoor target according to the present invention.

### DETAILED DESCRIPTION OF THE PREFERRED EMBODIMENT

Preferred embodiments of the present invention will be described in more detail below with reference to the drawings. However, the present invention can be implemented in various forms and should not be construed to be limited to the embodiments set forth herein. These embodiments are provided for a more thorough and complete understanding of the present invention, and revealing the scope of the present invention to those skilled in the art completely.

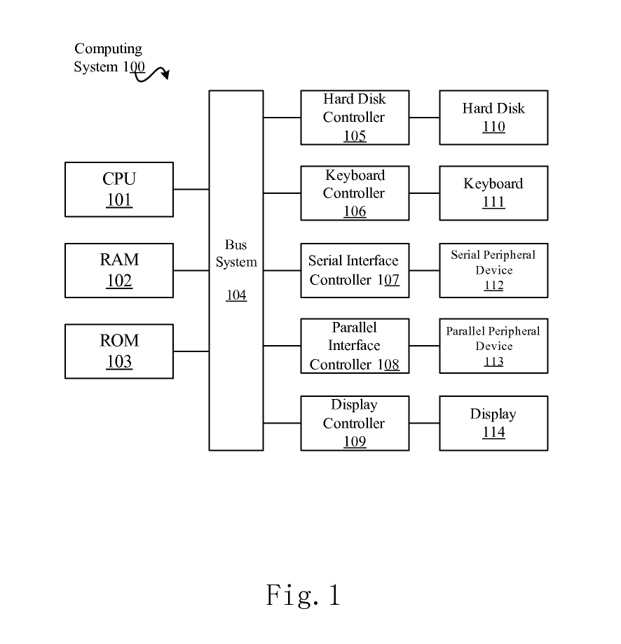

FIG. 1 shows an exemplary computing system 100 which is applicable to implement the embodiments of the present invention. As shown in FIG. 1, the computing system 100 can include: CPU (central processing unit) 101, RAM (random access memory) 102, ROM (read only memory) 103, system bus 104, hard disk controller 105, keyboard controller 106, serial interface controller 107, parallel interface controller 108, display controller 109, hard disk 110, keyboard 111, serial peripheral device 112, parallel peripheral device 113 and display 114. Among above devices, CPU 101, RAM 102, ROM 103, hard disk controller 105, keyboard controller 106, serial interface controller 107, parallel interface controller 108 and display controller 109 are coupled to the system bus 104. Hard disk 110 is coupled to hard disk controller 105. Keyboard 111 is coupled to keyboard controller 106. Serial peripheral device 112 is coupled to serial interface controller 107. Parallel peripheral device 113 is coupled to parallel interface controller 108. In addition, display 114 is coupled to display controller 109. It should be understood that the structure as shown in FIG. 1 is only for purpose of illustration rather than a limitation to the scope of the present invention. In some cases, some devices can be added or removed based on specific situations.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

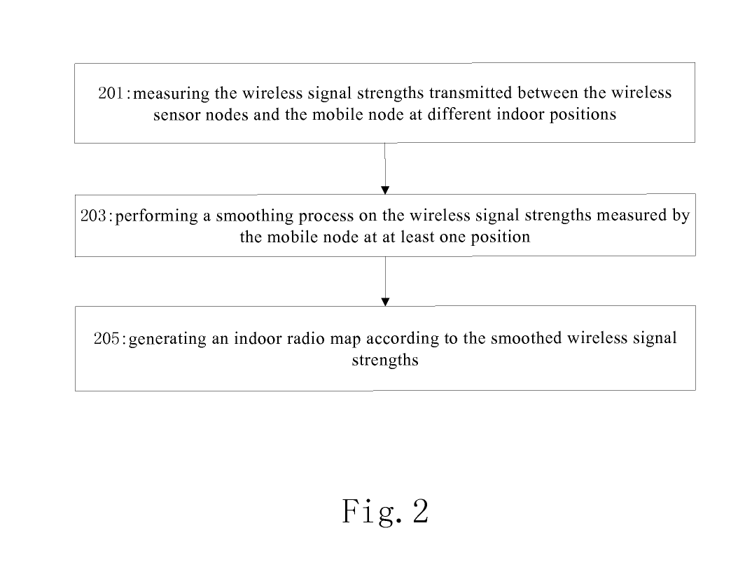

FIG. 2 shows a flowchart of a method for generating an indoor radio map according to the present invention. In the method, an indoor environment can be configured to be provided with wireless sensor nodes and at least one mobile node, the mobile node can move in the indoor environment, and the mobile node can perform wireless signal transmission with the wireless sensor nodes. At step 201, wireless signal strengths transmitted between the wireless sensor nodes and the mobile node at different indoor positions are measured. For example, for each wireless sensor node, the wireless signal strength transmitted between each wireless sensor node and the mobile node at different indoor positions are calculated. At step 203, a smoothing process is performed on the wireless signal strengths measured by the mobile node at least one position. At step 205, an indoor radio map is generated according to the wireless signal strengths after the smoothing process described above. Optionally, at step 205, an indoor radio map is generated according to a combination of the wireless signal strengths transmitted between the mobile node and different wireless sensor nodes after the smoothing process, and the indoor radio map indicates the wireless signal strengths transmitted between a plurality of wireless sensor nodes and the mobile node at different indoor positions.

The above method will be described in detail with reference to FIGS. 3-5 below. FIG. 3 is a schematic view showing a layout of wireless sensor nodes according to one embodiment of the present invention. It is assumed that a target in an indoor environment shown in FIG. 3 is to be located, and before locating, a series of processes will be performed on wireless signals in the indoor environment shown in FIG. 3 to prepare for the indoor localization. Given that there are 8 wireless sensor nodes, respectively N1-N8, arranged in the indoor environment shown in FIG. 3. These 8 wireless sensor nodes can transmit wireless signals (such as, WiFi, ZigBee, etc), and can be implemented by Mica2 nodes commonly used in the industry at present.

A mobile node is further provided (not shown in FIG. 3), which can receive wireless signals transmitted by the wireless sensor nodes. The mobile node can be bound to another device like a laptop computer, a mobile phone, etc., or can be formed as a separate apparatus (described in more detail hereinafter). The mobile node can sample at various indoor positions to receive wireless signals transmitted by various wireless sensor nodes. If the mobile node is bound to another device like a laptop computer, a mobile phone, etc., it can be carried by a person body to various positions for sampling. If the mobile node is formed as a separate apparatus, it can be designed as a robot to sample at various indoor positions.

Assume that in FIG. 3, the mobile node sets out from a start point to move along a straight line and measure the wireless signal strengths transmitted from various wireless sensor nodes N1-N8, and ultimately reaches an end point. Assuming that the mobile node moves along a straight line and the length from the start point to the end point is 42 meters in total. The example of straight movement in this embodiment is merely for the convenience of description, and in practical measurement, the mobile node can move along a predetermined route or any route as required, but does not necessarily move along a straight line as in this embodiment.

Although an example will be described below wherein the wireless sensor nodes transmit wireless signals and the mobile node receives wireless signals, the present invention can also be realized wherein the mobile node transmits wireless signals and wireless sensor nodes receives wireless signals. Step 201 of FIG. 2 can measure both the wireless signal strengths transmitted from the wireless sensor nodes to the mobile node, and the wireless signal strengths transmitted from the mobile node to the wireless sensor nodes. In the present invention, there can be one or more than one mobile nodes.

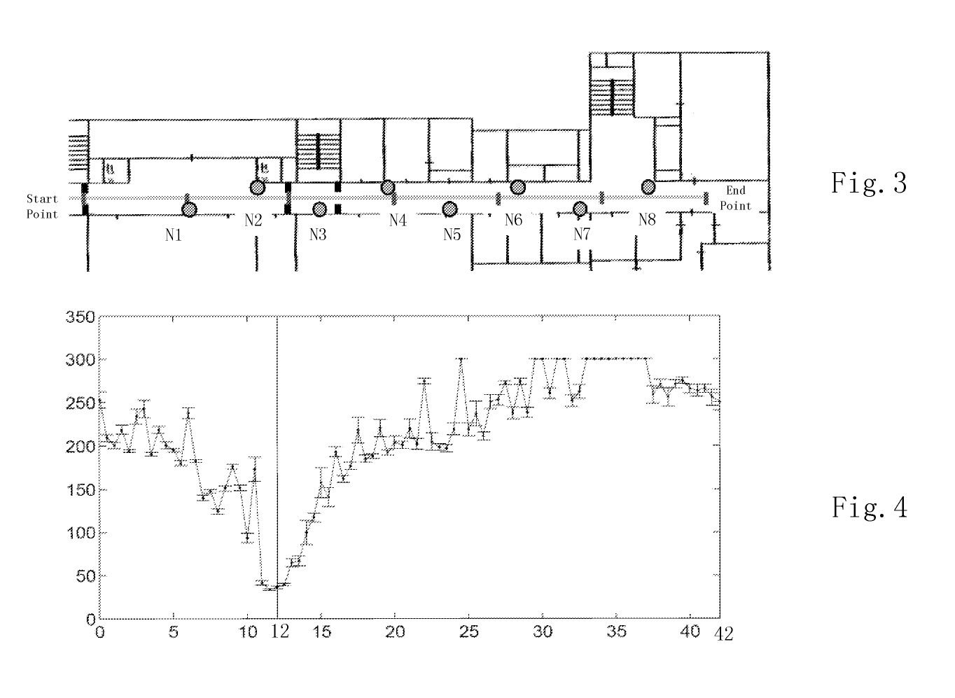

FIG. 4 is a schematic diagram showing the variation with positions of the measured wireless signal strengths transmitted between a mobile node and a wireless sensor node according to one embodiment of the present invention. The horizontal axis in FIG. 4 represents a distance from a start point of the mobile node, in a unit of meter (m). The vertical axis represents the signal strength measure of a wireless signal transmitted from a wireless sensor node N2 and received by the mobile node at a current position.

The strength measure of a wireless signal is in reverse to the wireless signal strength. The larger the strength of a wireless signal is, the smaller its strength measure value is, and the smaller the strength of the wireless signal is, the larger its strength measure value is. Because the wireless signal strength measures of the Mica2 node are normalized into an interval 0-255, the wireless signal strength measure values of the embodiment shown in FIG. 4 are also within 0-255. The present invention is not limited to the use of Mica2 nodes for wireless signal transmission, if other wireless sensor nodes are used, their wireless signal strengths can be measured in other manners. The present invention does not have a limitation in this regard, and Mica2 nodes are merely used as an example for description.

Assume that the mobile node samples the wireless signals transmitted from N2 at an interval of 0.5 m, and records the measured wireless signal strengths in FIG. 4 in the form of wireless signal strength measure values. During the movement of the mobile node from a start point to an end point, wireless signal strength measure values measured at a total of 85 positions is obtained. It can be seen from FIG. 4 that because the mobile node measures the wireless signal strength transmitted from N2 which is located at a distance of 12 m from the start point, the wireless signal strength measured by the mobile node at a distance of 12 m from the start point is the strongest (the wireless signal strength measure value is minimum), but when the mobile node moves away from N2, its measured wireless signal strength transmitted from N2 gradually decreases (the wireless signal strength measure value becomes larger).

At a certain sampling position, the mobile node can measure the wireless signal strength measure value of the wireless signal transmitted from the same wireless sensor node only once, or a plurality of times for subsequently recording their mean and variance. In the example of FIG. 4, for each sampling position, the mobile node measures the wireless signal strength measure value a plurality of times and records their mean (represented as black dots) and variance (represented as the distance between two short lines.

As can be seen from FIG. 4, since there are only small differences among a plurality of wireless signal strengths measured at each sampling position, the variance at each sampling point is not large. Therefore, according to another embodiment of the present invention, the measurement is performed only once, that is, wireless signal strength is measured only once, at each sampling position. As such, computing resources and computing time can be saved, and the accuracy of the resultant electronic map will not be affected in substance.

Similarly, the wireless signals transmitted by each of the plurality of wireless sensor nodes can be measured, and schematic diagrams of variations with mobile node positions of wireless signal strengths similar to FIG. 4 can be plotted. According to the embodiment shown in FIG. 3, a total of 8 schematic diagrams of variations with mobile node positions of wireless signal strengths can be plotted.

According to an embodiment of the present invention, the present invention further determines the indoor positions of the mobile node under the measured wireless signal strengths. Determining indoor positions will facilitate locating a target by finding a reference wireless signal strength vector closest to a target wireless signal strength vector during a subsequent process of locating an indoor target (which will be described in detail hereinafter). Determining indoor positions of the mobile node under measured wireless signal strengths can be achieved in a variety of ways. In one embodiment, an accurate indoor position of the mobile node when measuring the strength of a wireless signal transmitted by a wireless sensor node each time can be manually measured and recorded. In another embodiment, a plurality of short range signal transmitters (which can transmit at least one of Bluetooth or RFID signals) can be arranged on a path along which the mobile node is moved.

For example, suppose that the mobile node will move along a straight line from a start point to an end point (a total of 42 meters) and will measure the wireless signal strength once at every 0.5 meter, then a total of 85 short range signal transmitters can be arranged at 85 points from the start point to the end point, and the current indoor position of the mobile node can be determined through communicating with the short range signal transmitters. In still another embodiment, if the mobile node is mounted on a robot moving automatically indoor along a predetermined route and the wireless signal strength is measured (the robot will be described in detail hereinafter), the indoor position when measuring the wireless signal strength each time can be determined in advance according to the indoor moving route and moving speed of the robot. The present invention does not exclude other ways of determining the indoor position of the mobile node when measuring the wireless signal strength every time.

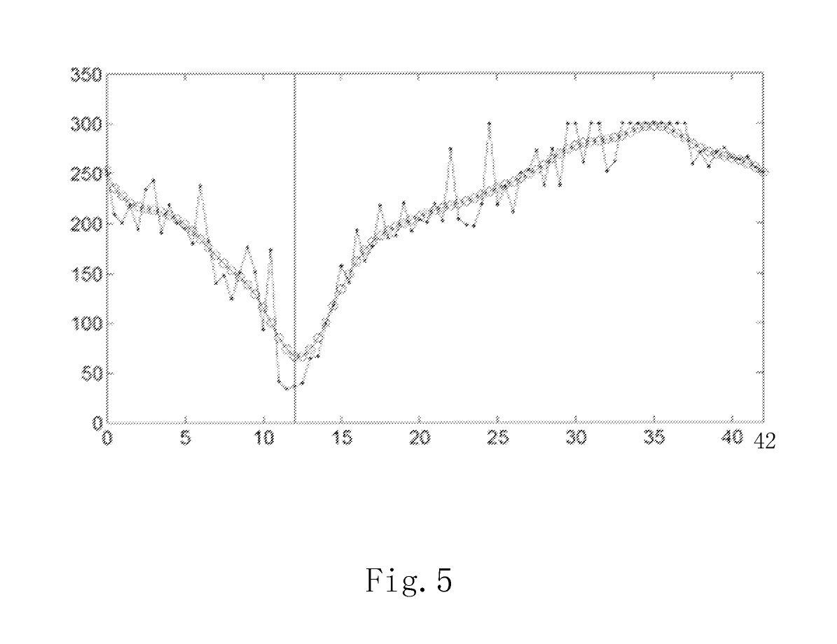

At step 203 of FIG. 2, a smoothing process is performed on the wireless signal strength measured at least one position by the mobile node, which will be described below with reference to FIG. 5.

FIG. 5 is a schematic diagram showing measured wireless signal strengths after the smoothing process according to one embodiment of the present invention. The adverse influence of multipath effect on signal transmission has been mentioned above. In order to reduce such adverse influence of multipath effect, the present invention has creatively proposed to perform a smoothing process on wireless signal strengths. According to one embodiment of the present invention, the smoothing process includes averaging the wireless signal strengths measured by the mobile node at the at least one position and adjacent one or more positions, as the wireless signal strength of the mobile node at the at least one position. For example, the wireless signal strength measure values measured at a total of 5 positions around the present position are averaged, as the wireless signal strength measure value of the present position. The present invention can also use other embodiments to smooth the wireless signal strengths. For example, the signal strength measures of FIG. 5 can be transformed into the frequency domain through a Fourier transform, then a low pass filter is used to filter out high frequency components to obtain a smoothed wireless signal strength measure value distribution, and finally, an optimized indoor radio map is obtained. The present invention can use other methods to perform the smoothing process.

FIG. 5 shows the result of performing smoothing process on wireless signal strength measure values on the basis of FIG. 4. In FIG. 5, wireless signal strength measure values after the smoothing process are represented by a series of circles.

Optionally, performing a smoothing process can further include performing another smoothing process on the smoothed wireless signal strengths to achieve the effect of further reducing the influence of multipath effect. For example, three smoothing processes can be performed in sequence. The number of the smoothing processes to be performed depends on the degree of multipath effect, and the present invention does not have a limitation in this regard.

At step 205 of FIG. 2, an indoor radio map is generated according to the wireless signal strengths after the smoothing process, which will be described hereinafter in conjunction with equation 1.

According to the aforementioned assumption of a total of 85 sampling points and 8 wireless sensor nodes, 85×8 (totally 680) wireless signal strength measure values are obtained after the smoothing process. A measure value can be represented as V_{(i,j)}, wherein i is 1 to 85, j is 1 to 8, and V_{(i,j)} represents the wireless signal strength measure value received from the jth wireless sensor node at the ith position after the smoothing process.

$$[ {V}_{( 1 , 1 )} , {V}_{( 1 , 2 )} , {V}_{( 1 , 3 )} , {V}_{( 1 , 4 )} , {V}_{( 1 , 5 )} , {V}_{( 1 , 6 )} , {V}_{( 1 , 7 )} , {V}_{( 1 , 8 )} ] \\ [ {V}_{( 2 , 1 )} , {V}_{( 2 , 2 )} , {V}_{( 2 , 3 )} , {V}_{( 2 , 4 )} , {V}_{( 2 , 5 )} , {V}_{( 2 , 6 )} , {V}_{( 2 , 7 )} , {V}_{( 2 , 8 )} ] \\ … \\ [ {V}_{( 85 , 1 )} , {V}_{( 85 , 2 )} , {V}_{( 85 , 3 )} , {V}_{( 85 , 4 )} , {V}_{( 85 , 5 )} , {V}_{( 85 , 6 )} , {V}_{( 85 , 7 )} , {V}_{( 85 , 8 )} ] \qquad Equation 1$$

Wherein [V_{1,1)} . . . V_{(1,8)}] is referred to as a reference wireless signal strength vector. The reference wireless signal strength vector represents a combination of wireless signal strengths transmitted between the mobile node at a certain position and different wireless sensor nodes. In this example, it represents a signal strength measure value vector obtained after a smoothing process on the wireless signals received by the mobile node at a first position from 8 wireless sensor nodes. Equation 1 is composed of 85 reference wireless signal strength vectors, which is a representation of an indoor radio map.

An indoor radio map can be represented in a variety of forms like equation, table, graph, etc. The present invention does not have any limitation to data structures of the electronic map, and the equation aforementioned is merely an example for description.

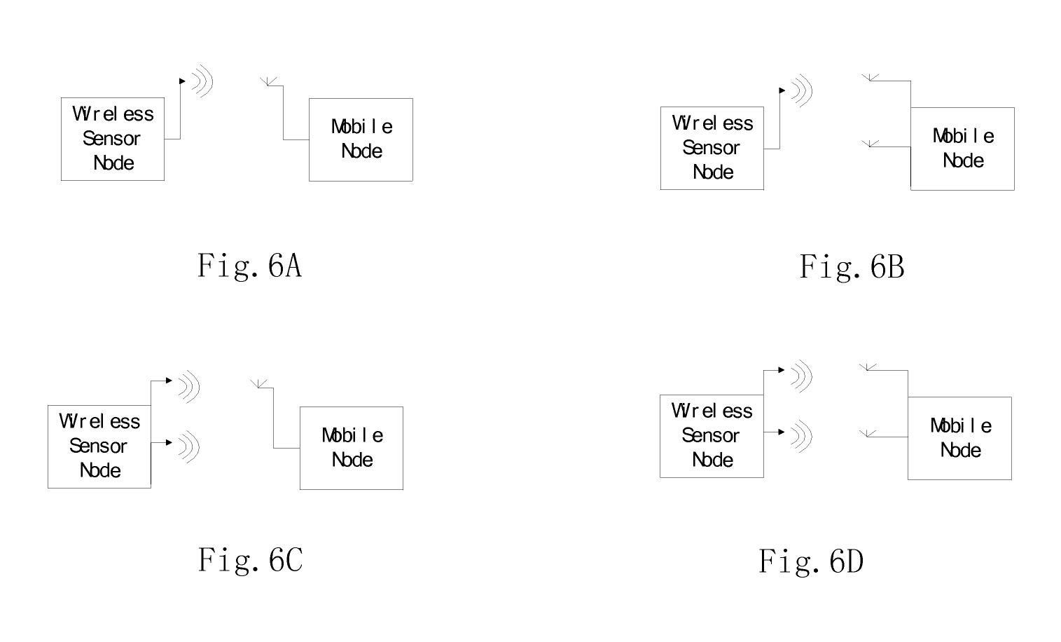

Hereinafter, it will be explained in connection with FIGS. 6A to 6D how to further reduce the influence of multipath effect by arrangement of a plurality of antennas.

FIG. 6A is a schematic diagram showing a SISO (Single Input Single Output) signal transmission structure according to one embodiment of the present invention. In the example shown in FIG. 6A, one transmitting antenna is mounted on one wireless sensor node, and one receiving antenna is mounted on one mobile node. The mobile node receives a wireless signal transmitted by the wireless sensor node through a single receiving antenna.

FIG. 6B is a schematic diagram showing a SIMO (Single Input Multiple Output) signal transmission structure according to one embodiment of the present invention. In the example shown in FIG. 6B, one transmitting antenna is mounted on one wireless sensor node, and two receiving antennas are mounted on one mobile node. The mobile node can receive two wireless signals from a wireless sensor node through the two receiving antennas. Since the two antennas are mounted on different positions on the mobile node, there can be a difference between the received two wireless signal strength measure values. When the multipath effect is not taken into account, the two wireless signal strengths should be substantially the same. However, when multipath effect exists, the difference can be notable. Thus, through calculating an average of the wireless signal strengths transmitted between the wireless sensor node and the mobile node using different antennas, multipath effect can be eliminated to some extent.

According to one embodiment of the present invention, firstly, wireless signal strengths transmitted between the wireless sensor code and the mobile node using different antennas can be measured, then an average of the wireless signal strengths is calculated, and after that, a smoothing process is performed on averaged wireless signal strengths according to the method aforementioned. According to another embodiment of the present invention, firstly, wireless signal strengths transmitted between the wireless sensor code and the mobile node using different antennas can be measured, then a smoothing process is performed on the measured wireless signals according to the method aforementioned, and after that, an average of the smoothed signal strengths of the wireless signals obtained with the mobile node using different antennas is calculated.

FIG. 6C is a schematic diagram showing a MISO (Multiple Input Single Output) signal transmission structure according to one embodiment of the present invention. In the example shown in FIG. 6C, two transmitting antennas are mounted on one wireless sensor node and one receiving antenna is mounted on one mobile node. The mobile node can receive two wireless signals from one wireless sensor node through one receiving antenna. Similarly, when multipath effect is not taken into account, the two wireless signal strengths should be substantially the same. However, when multipath effect exists, the difference between the two wireless signal strengths can be notable. Thus, through calculating an average of the wireless signal strengths transmitted between the mobile node and different antennas of the at least one wireless sensor node, multipath effect can be eliminated to some extent.

According to one embodiment of the present invention, firstly, the wireless signal strengths transmitted between the mobile node and the wireless sensor code using different antennas can be measured, then an average of the wireless signal strengths is calculated, and after that, a smoothing process is performed on averaged wireless signal strengths according to the method aforementioned. According to another embodiment of the present invention, firstly, wireless signal strengths transmitted between the mobile node and the wireless sensor node using different antennas can be measured, then a smoothing process is performed on the measured wireless signals according to the method aforementioned, and after that, an average of the smoothed signal strengths of the wireless signals obtained with the wireless sensor node using different antennas is calculated.

FIG. 6D is a schematic diagram showing a MIMO (Multiple Input Multiple Output) signal transmission structure according to one embodiment of the present invention. In the example shown in FIG. 6D, two transmitting antennas are mounted on one wireless sensor node, and two receiving antennas are mounted on one mobile node too. Through the two receiving antennas, four wireless signals can be received by the mobile node from the wireless sensor node provided with two antennas. Similarly, when multipath effect is not taken into account, the four wireless signals should have substantially the same strength. However, when multipath effect exists, the differences among the four wireless signals can be notable. Thus, through calculating an average of the four wireless signal strength measure values, multipath effect can be eliminated to some extent. Similarly, the present invention does not have a limitation to the order of two steps of calculating an average and performing a smoothing process, and the order of these two can be arranged according to different needs in different implementations.

As can be seen, according to one embodiment of the present invention, a further smoothing process can be performed on the averaged wireless signal strength measure values to further eliminate the influence of multipath effect, so as to realize more accurate indoor localization.

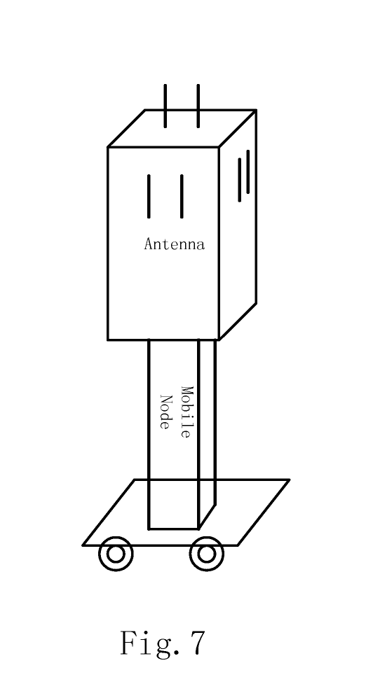

Next it will be explained how to measure wireless signal strengths through a robot mobile node in connection to FIG. 7.

FIG. 7 is a schematic diagram showing a mobile node according to one embodiment of the present invention. In the example of FIG. 7, a mobile node is carried by a robot, which can move indoors to measure the wireless signal strengths transmitted from the wireless sensor nodes.

The present invention does not have a limitation to the way in which the robot moves. According to one embodiment of the present invention, the robot can move indoors following a predetermined route. According to another embodiment of the present invention, the robot can move indoors via manual remote control. According to still another embodiment of the present invention, the robot can randomly move indoors, and after a sufficiently long period, the robot can traverse all the indoor positions, so that sufficient wireless signal strength data can be collected. Of course, the present invention does not exclude robot movement in other manners.

Furthermore, the present invention does not have a limitation to the movement speed of the robot. According to one embodiment of the present invention, the robot is arranged to move at a uniform speed, so that during a continuous movement at a uniform speed, the mobile node thereon measures the wireless signal strengths transmitted with each of the plurality of wireless sensor nodes at different indoor positions. In this embodiment, if the robot further moves indoors along a predetermined route at a uniform speed, the indoor position of the robot can be determined in advance when the robot measuring the strength of every wireless signal. Particularly, since the robot is moving continuously at a uniform speed, at every sampling point, the robot can make one or a small number of measurements on the wireless signal transmitted by the wireless sensor node, so that measurement costs can be reduced without producing a substantive influence on the accuracy of the resultant electronic map. According to other embodiments of the present invention, the robot can move at a non-uniform speed.

Further, the present invention does not exclude carrying a mobile node manually (for example, the mobile node being mounted on a laptop computer, mobile phone or a stand-alone receiving device) to move it continuously at a uniform speed indoors.

As can be seen from the embodiment shown in FIG. 7, the robot can receive wireless signals transmitted from the wireless sensor nodes with a plurality of antennas, which can further reduce the influence of multipath effect. In other embodiments, the robot can receive the wireless signals with a single antenna.

Optionally, in addition to measuring wireless signal strengths, the mobile node of the present invention can consider other environmental factors, e.g., measuring the wireless signal strengths transmitted between the mobile node and the wireless sensor nodes at different indoor positions under different population densities. Since human bodies have an obstacle effect on wireless signals, it is likely that an electronic map measured in a clear room is different from an electronic map measured in a crowded room. For example, for a large exhibition, if an electronic map is generated in a clear condition while a target is to be located in a crowded condition, the final result of locating is likely to be inaccurate. Thus, it is necessary to generate electronic maps under different population densities, so as to locate an indoor target according to an electronic map of the same population density. Population density can be determined in many ways. In one embodiment, an indoor picture can be taken with a camera and then the population density is recognized through an image recognition technique. In another embodiment, population density can be determined or estimated manually.

Optionally, in addition to population density, indoor humidity can become one of factors that can affect an electronic map. Thus, according to one embodiment of the present invention, the wireless signal strengths transmitted between the mobile node at different indoor positions and the wireless sensor nodes can be measured under different indoor humidity. In doing so, when locating an indoor target, the position of the target can be determined according to an electronic map generated under the same humidity.

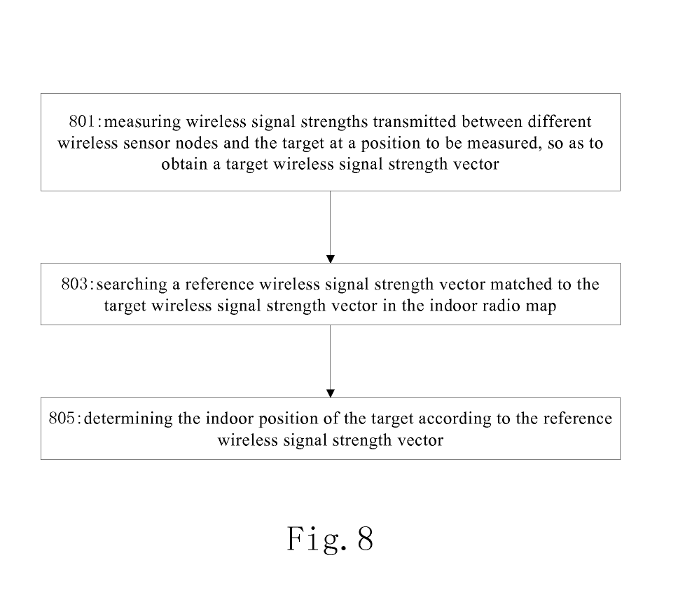

Hereinafter, a method for locating an indoor target will be described in connection with FIG. 8. FIG. 8 shows a flow of a method for locating an indoor target according to the present invention. At step 801, the wireless signal strengths transmitted between a target at a position to be measured and different wireless sensor nodes are measured to obtain a target wireless signal strength vector. In the following equation 2, for example, V′₍ⱼ₎ represents the wireless signal strength measure values received from N1-N8 by the target at an indoor position to be located, wherein j is a number between 1 to 8.

[V′₍₁₎,V′₍₂₎,V′₍₃₎,V′₍₄₎,V′₍₅₎,V′₍₆₎,V′₍₇₎,V′₍₈₎] Equation (2)

Equation 2 is also called as a target wireless signal strength vector. The target wireless signal strength vector in the present invention can be represented in any data structure forms like equation, table, graph, etc., and the equation aforementioned is merely an example for description and should not be construed as limitation to the present invention.

The same problem can be encountered in target locating as that in generating an indoor radio map, that is, the influence of multipath effect. In other words, the measured wireless signal strengths transmitted between the target at a location to be measured and different wireless sensor nodes can also be distorted due to multipath effect. If the measured wireless signal strengths transmitted between the target and wireless sensor nodes are inaccurate, an incorrect judgment can be made in target locating. Hereinafter, two embodiments are given as examples to explain how to reduce the influence of multipath effect when measuring the wireless signal strengths transmitted between the target and the wireless sensor nodes.

In a first embodiment, the movement trace of the target can be tracked, and the wireless signal strengths transmitted between the target and different wireless sensor nodes that are measured by the target at various sampling points during its movement can be recorded (recorded in the form of wireless signal strength measure values). Various sampling points can be determined in many ways, such as, it can be defined to measure the wireless signal strengths transmitted between the target and different wireless sensor nodes once at an interval of a predetermined length (for example, 0.5 m) or a predetermined period of time (for example, 2 s); it is also possible to determine on which sampling point the wireless signal strengths transmitted between the target and different wireless sensor nodes should be measured based on a predetermined condition (for example, if the moving speed of the target is below a predetermined value, the wireless signal strengths transmitted between the target and different wireless sensor nodes are measured).

After that, a smoothing process is performed on the measured wireless signals strengths transmitted between the target and different wireless sensor nodes. For example, the smoothing process can be performed by averaging wireless signal strengths of adjacent sampling points. In such an embodiment, since it is only possible to obtain a forward trace of the target movement (i.e., which sampling point the target will move toward before the position to be measured) but impossible to obtain a backward trace of target movement (i.e., which sampling point the target will move toward after the position to be measured), the smoothing process can only perform a smoothing process on the wireless signal measured at the position to be measured according to the wireless signals transmitted between the target and different wireless sensor nodes which are measured at adjacent sampling points in the forward track. If the application does not require locating the target in real-time, a smoothing process can be performed on the wireless signal measured at the position to be measured with the wireless signals measured at the sampling points in the forward track and the sampling points in the backward track.

In a second embodiment, the influence of multipath effect can be reduced by employing multi-antenna technology (the principle of reducing the influence of multipath effect by employing multi-antenna technology has been described in detail above, and will not be repeated herein). A plurality of antennas can be provided on the target to perform wireless signal transmission with the different wireless sensor nodes, and an average of wireless signal strengths transmitted between the target using different antennas and the wireless sensor nodes can be calculated. Also, a plurality of antennas can be provided on each wireless sensor node to perform wireless signal transmission with the target, and an average of wireless signal strengths transmitted between the target and the different antennas of the at lease one wireless sensor node can be calculated. It is also possible to provide a plurality of antennas on both the target and each of wireless sensor nodes to perform wireless signal transmission and average the wireless signal strengths transmitted by different antennas.

At step 803, a reference wireless signal strength vector matched with the target wireless signal strength vector is searched in the indoor radio map. According to one embodiment of the present invention, a distance D₍ᵢ₎ between a target wireless signal strength vector V′₍ⱼ₎ and any reference wireless signal strength vector V_{(i,j)} can be calculated according to equation 3 below.

D₍ᵢ₎={square root over (Σ(V′₍ⱼ₎−V_{(i,j)}²)}, wherein j=1-8 Equation 3

D₍ᵢ₎ represents the distance between the target wireless signal strength vector and a reference wireless signal strength vector at the ith position, a larger value of D₍ᵢ₎ indicates a farther distance of the target from the ith position, and a smaller value of D₍ᵢ₎ indicates a closer distance of the target to the ith position.

The distance between two vectors also can be compared in other ways in the present invention, for example, through calculating a distance between two vectors as Σ|V′₍ⱼ₎−V_{(i,j)}|. The above is merely an example of calculating the distance between two vectors and the present invention is not limited thereto.

At step 805, an indoor position of the target is determined according to the reference wireless signal strength vector. For example, a position with minimum D₍ᵢ₎ is determined as the indoor position of the target.

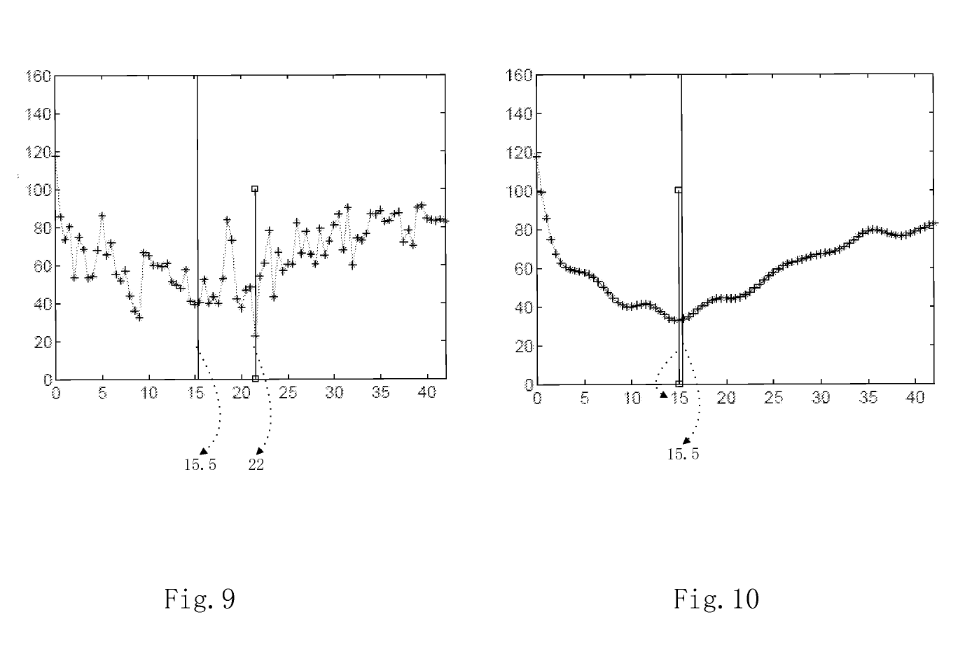

Next, the effects of more accurate locating of the present invention will be further described in connection with FIGS. 9 and 10. FIG. 9 is a schematic diagram showing signal strengths without eliminating indoor localization error caused by the multipath effect. The horizontal axis of FIG. 9 represents the distance from a start point. The vertical axis of FIG. 9 represents a distance D₍ᵢ₎ between a target wireless signal strength vector, which is obtained without a smoothing process on wireless signal strength measure values according to the present invention, and a reference wireless signal strength vector at the ith position (wherein, i=1 to 85). It is assumed that the target actually stays at an position at a distance 15.5 m from the start point, due to the influence of multipath effect, the calculated target wireless signal strength vector is closest to the reference wireless signal strength vector measured at a distance of 22 m, therefore the position of the target is determined as 22 m from the start point, which is obviously a false determination, with an error of 6.5 m.

FIG. 10 is a schematic diagram showing signal strengths wherein the influence of multipath effect has been reduced to improve the accuracy of locating according to one embodiment of the present invention. In the example shown in FIG. 10, due to the smoothing process on wireless signal strength measure values according to the method for the present invention, the influence of multipath effect can be greatly reduced. The horizontal axis of FIG. 10 represents a distance from a start point. The vertical axis of FIG. 10 represents a distance D₍ᵢ₎ between a target wireless signal strength vector, which is obtained through performing a smoothing process on wireless signal strength measure values according to the present invention, and a reference wireless signal strength vector at the ith position (wherein, i=1 to 85). In the example shown in FIG. 10, the position of the target is determined as at a distance of 15 m from the start point, only having an error of 0.5 m deviated from the actual position of the target. It can be seen that the present invention can greatly improve the accuracy of indoor localization.

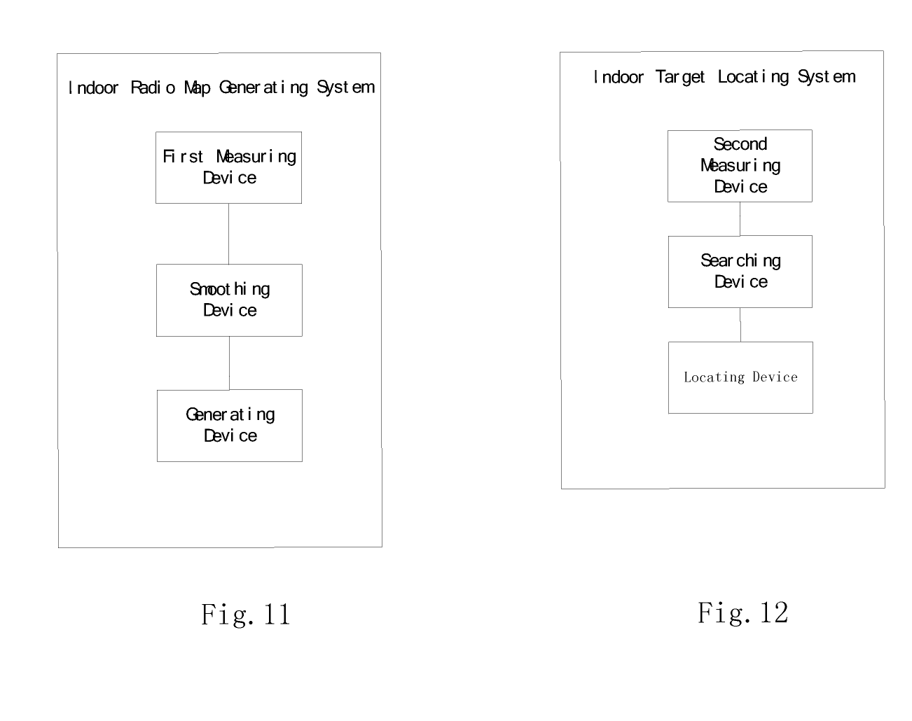

The indoor radio map generation method and an indoor target locating method for the present invention have been described above. Hereinafter, an indoor radio map generation system and an indoor target locating system will be described in connection with FIG. 11 and FIG. 12 under the same inventive concept of the present invention, wherein the same or corresponding implementation details have been completely and fully described above, and thus will not be repeated hereinafter.

FIG. 11 shows a block diagram of an indoor radio map generation system according to the present invention. An indoor environment can be configured to be provided with wireless sensor nodes and at least one mobile node, the mobile node can move indoors, and the mobile node can perform wireless signal transmission with the wireless sensor nodes. The system shown in FIG. 11 includes a first measurement device, a smoothing device and a generation device. The first measurement device is configured to measure the wireless signal strengths transmitted between the mobile node at different indoor positions and the wireless sensor nodes. The smoothing device is configured to perform a smoothing process on the wireless signal strengths measured by the mobile node at least one position. The generation device is configured to generate an indoor radio map according to the smoothed wireless signal strengths. Optionally, the generation device is configured to generate an indoor radio map according to a combination of wireless signal strengths transmitted between the mobile node and different wireless sensor nodes which have been smoothed according to the above smoothing process.

Optionally, the smoothing device is further configured to: average the wireless signal strengths measured by the mobile node at the at least one position and one or more adjacent positions thereof as the wireless signal strength of the mobile node at the at least one position.

Optionally, the smoothing device is further configured to: perform a further smoothing process on the smoothed wireless signal strengths.

Optionally, at least one wireless sensor node employs a plurality of antennas for wireless signal transmission, the indoor radio map generation system further includes a first calculation device configured to calculate an average of the wireless signal strengths transmitted between the mobile node and different antennas of the at least one wireless sensor node.

Optionally, the mobile node employs a plurality of antennas for wireless signal transmission, and the indoor radio map generation system further includes a second calculation device configured to calculate an average of the wireless signal strengths transmitted between the mobile node using different antennas and the at least one wireless sensor node.

Optionally, the indoor radio map generation system further includes a determination device configured to determine an indoor position of the mobile node under the measured wireless signal strength.

Optionally, the determination device is further configured to determine an indoor position of the mobile node through reading at least one of a Bluetooth signal or a RFID signal.

Optionally, the first measurement device is further configured to measure the wireless signal strengths transmitted between the mobile node, which is continuously moved at a uniform speed, at different indoor positions and the wireless sensor nodes.

Optionally, the first measurement device is further configured to measure, under different population densities, the wireless signal strengths transmitted between the mobile node at different indoor positions and the wireless sensor nodes.

FIG. 12 shows a block diagram of a system of locating an indoor target according to the present invention. The system of locating an indoor target shown in FIG. 12 is a system of locating an indoor target according to the electronic map that is generated by the indoor radio map generation system shown in FIG. 11. The system shown in FIG. 12 includes a second measurement device, a searching device, and a locating device. The second measurement device is configured to measure the wireless signal strengths transmitted between a target at a position to be measured and different wireless sensor nodes to obtain a target wireless signal strength vector. The searching device is configured to search a reference wireless signal strength vector matching the target wireless signal strength vector in the indoor radio map. The locating device is configured to determine the indoor position of the target according to the reference wireless signal strength vector.

Optionally, at least one wireless sensor node employs a plurality of antennas for wireless signal transmission, and the indoor target locating system further includes a third calculation device (not shown in the figure), the third calculation device is configured to calculate an average of the wireless signal strengths transmitted between the target and different antennas of the at least one wireless sensor node.

Optionally, the target employs a plurality of antennas for wireless signal transmission, and the indoor target location system further includes a fourth calculation device (not shown in the figure), the fourth calculation device being configured to calculate an average of the wireless signal strengths transmitted between the target using different antennas and the wireless sensor nodes.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Terms were chosen in order to best explain the principles of the invention and the practical application or improvement of techniques in market, and to enable those of ordinary skill in the art to understand the invention for various embodiments with various modifications as are suited to the particular use contemplated.

We claim:

1. A computer implemented method for generating an indoor radio map, wherein an indoor environment is configured to be provided with wireless sensor nodes and at least one mobile node, wherein the mobile node can move in the indoor environment and perform wireless signal transmission with the wireless sensor nodes, the method comprising:
measuring the wireless signal strengths transmitted between the wireless sensor nodes and the mobile node at different indoor positions;
performing a smoothing process on the wireless signal strengths measured by the mobile node in at least one position; and
generating an indoor radio map according to the smoothed wireless signal strengths;
wherein at least one of the steps is carried out by a processor device.

2. The method according to claim 1, wherein the smoothing process comprises:
averaging the wireless signal strengths measured by the mobile node at the at least one position and one or more adjacent positions thereof as the wireless signal strength of the mobile node at the at least one position.

3. The method according to claim 1, wherein the smoothing process comprises:
performing a further smoothing process on the smoothed wireless signal strengths.

4. The method according to claim 1, wherein at least one wireless sensor node employs a plurality of antennas for wireless signal transmission, the method further comprising:
calculating an average of the wireless signal strengths transmitted between the mobile node and different antennas of the at least one wireless sensor node.

5. The method according to claim 1, wherein the mobile node employs a plurality of antennas for wireless signal transmission, and the method further comprising:
calculating an average of the wireless signal strengths transmitted between the wireless sensor nodes and the mobile node using different antennas.

6. The method according to claim 1, further comprising:
determining an indoor position of the mobile node under the measured wireless signal strength.

7. The method according to claim 1, wherein measuring the wireless signal strengths comprises:
measuring the wireless signal strengths transmitted between the wireless sensor nodes and the mobile node at different indoor positions when being continuously moved at a uniform speed.

8. The method according to claim 1, further comprising:
measuring wireless signal strengths transmitted between different wireless sensor nodes and a target, so as to obtain a target wireless signal strength vector;
searching a reference wireless signal strength vector matched to the target wireless signal strength vector in the indoor radio map; and
determining the indoor position of the target according to the reference wireless signal strength vector.

9. The method according to claim 8, wherein at least one wireless sensor node employs a plurality of antennas for wireless signal transmission, the method further comprising:
calculating an average of the wireless signal strengths transmitted between the target and different antennas of the at least one wireless sensor node.

10. The method according to claim 8, wherein the target employs a plurality of antennas for wireless signal transmission, and the method further comprising:
calculating an average of the wireless signal strengths transmitted between the target using different antennas and the wireless sensor nodes.

11. A system of generating an indoor radio map, wherein an indoor environment is configured to be provided with wireless sensor nodes and at least one mobile node, the mobile node can move in the indoor environment, and the mobile node can perform wireless signal transmission with the wireless sensor nodes, the system comprises:
a first measuring device configured to measure the wireless signal strengths transmitted between the wireless sensor nodes and the mobile node at different indoor positions;
a smoothing device configured to perform a smoothing process on wireless signal strengths measured by the mobile node in at least one position; and
a generating device configured to generate an indoor radio map according to the smoothed wireless signal strengths.

12. The system according to claim 11, wherein the smoothing device is further configured to:
average the wireless signal strengths measured by the mobile node at the at least one position and one or more adjacent positions thereof as the wireless signal strength of the mobile node at the at least one position.

13. The system according to claim 11, wherein the smoothing device is further configured to:
perform a further smoothing process on the smoothed wireless signal strengths.

14. The system according to claim 11, wherein at least one wireless sensor node employs a plurality of antennas for wireless signal transmission, and the system further comprising:
a first calculation device configured to calculate an average of the wireless signal strengths transmitted between the mobile node and different antennas of the at least one wireless sensor node.

15. The system according to claim 11, wherein the mobile node employs a plurality of antennas for wireless signal transmission, and the system further comprising:
a second calculation device configured to calculate an average of the wireless signal strengths transmitted between the mobile node using different antennas and the wireless sensor nodes.

16. The system according to claim 11, further comprising:
a determination device configured to determine an indoor position of the mobile node under the measured wireless signal strength.

17. The system according to claim 11, wherein the first measurement device is further configured to:
measure the wireless signal strengths transmitted between the wireless sensor nodes and the mobile node at different indoor positions when being continuously moved at a uniform speed.

18. A system according to claim 11, further comprising:
a second measurement device configured to measure wireless signal strengths transmitted between different wireless sensor nodes and a target, so as to obtain a target wireless signal strength vector;
a searching device configured to search a reference wireless signal strength vector matched to the target wireless signal strength vector in the indoor radio map; and
a locating device configured to determine the indoor position of the target according to the reference wireless signal strength vector.

19. The system according to claim 18, wherein at least one wireless sensor node employs a plurality of antennas for wireless signal transmission, and the system further comprising:
a third calculation device for calculating an average of the wireless signal strengths transmitted between the target and different antennas of the at least one wireless sensor node.

20. The system according to claim 18, wherein the target employs a plurality of antennas for wireless signal transmission, and the system further comprising:
a fourth calculation device for calculating an average of the wireless signal strengths transmitted between the target using different antennas and the wireless sensor nodes.
